(19) United States
(12) Patent Application Publication
(10) Pub. No.: US 2024/0044376 A1
(43) Pub. Date: Feb. 8, 2024

(54) CONSTANT VELOCITY JOINT

(71) Applicant: TOYOTA JIDOSHA KABUSHIKI KAISHA, Toyota-shi (JP)

(72) Inventor: Satoshi JINNO, Miyoshi-shi (JP)

(73) Assignee: TOYOTA JIDOSHA KABUSHIKI KAISHA, Toyota-shi (JP)

(21) Appl. No.: 18/365,537

(22) Filed: Aug. 4, 2023

(30) Foreign Application Priority Data
Aug. 5, 2022 (JP) 2022-125882

(51) Int. Cl. F16D 3/224

(52) U.S. Cl. CPC F16D 3/224; F16D 2003/22303

(57) ABSTRACT

A constant velocity joint includes: an outer race having outside ball grooves; an inner race having inside ball grooves; and balls interposed between the outside and inside ball grooves that cooperate to constitute groove portions. The groove portions include first and second groove portions. In the first groove portion, a radial distance between the outside and inside ball grooves is increased in a direction toward an opening end of the outer race when a joint angle is 0 degree. In the second groove portion, a radial distance between the outside and inside ball grooves is reduced in a direction toward the opening end of the outer race in the reference state. A radius of a second outside arc of the outside ball groove of the second groove portion is larger than a radius of a first outside arc of the outside ball groove of the first groove portion.

This application claims priority from Japanese Patent Application No. 2022-125882 filed on Aug. 5, 2022, the disclosure of which is herein incorporated by reference in its entirety.

### FIELD OF THE INVENTION

The present invention relates to a to a constant velocity joint that is to be provided in a vehicle.

### BACKGROUND OF THE INVENTION

There is known a constant velocity joint including a cup-shaped outer race having a plurality of outside ball grooves provided in an inner circumferential surface thereof, an inner race having a plurality of inside ball grooves provided in an outer circumferential surface thereof and disposed inside the outer race, a plurality of balls interposed between the outside ball grooves and the inside ball grooves to transmit a torque, and a cage holding the plurality of balls. This is the constant velocity joint described in Patent Document 1.

Patent Document 1 discloses a structure having a first groove portion and a second groove portion. In the first groove portion, an opening angle, which is defined by a tangent between the outside ball groove and the ball and a tangent between the inside ball groove and the ball that intersect with each other, is opened toward a cup opening end of the outer race that is one of axially opposite ends of the outer race, in a reference state in which axes of the outer race and the inner race lie in a straight line with a joint angle defined by the axes being 0 degree. In the second groove portion, the opening angle is opened toward a cup bottom end of the outer race that is the other of the axially opposite ends of the outer race.

### PRIOR ART DOCUMENTS

### Patent Documents

[Patent Document 1]

Japanese Unexamined Patent Application Publication No. 2019-183883

### SUMMARY OF THE INVENTION

A force, with which the outside ball groove and the inside ball groove push out the ball, is determined by a product of a load applied between the ball and each ball groove (ball groove load) and the opening angle (ball groove load×opening angle). In the constant velocity joint as described in Patent Document 1, when the opening angle of the second groove portion crosses 0 (deg) in a high joint angle region, each ball groove cannot push out the ball and the ball is locked. At this time, if the load applied to the ball is increased, noise and vibration may be generated when the ball is unlocked.

It is therefore an object of the present invention to provide a constant velocity joint capable of suppressing noise and vibration generated when a ball interposed between ball grooves is released from a locked state.

According to a first aspect of the present invention, there is provided a constant velocity joint comprising: a cup-shaped outer race having a plurality of outside ball grooves provided in an inner circumferential surface thereof; an inner race having a plurality of inside ball grooves provided in an outer circumferential surface thereof, the inner race being disposed inside the outer race in a radial direction of the outer race; and a plurality of balls interposed between the outside ball grooves and the inside ball grooves, so as to transmit a torque between the outer race and the inner race. The outside ball grooves and the inside ball grooves cooperate to constitute a plurality groove portions, such that each of the balls is disposed in a corresponding one of the groove portions. The groove portions include a first groove portion in which a radial distance between a corresponding one of the outside ball grooves and a corresponding one of the inside ball grooves in the radial direction is increased in a direction toward an opening end that is one of axially opposite ends of the outer race, in a reference state in which axes of the outer race and the inner race lie in a straight line with a joint angle defined by the axes being 0 degree. The groove portions further include a second groove portion in which a radial distance between a corresponding one of the outside ball grooves and a corresponding one of the inside ball grooves in the radial direction is reduced in the direction toward the opening end of the outer race, in the reference state. The corresponding one of the outside ball grooves constituting the first groove portion is defined by a first outside arc in an outer-race cross section that is perpendicular to the axis of the outer race, and the corresponding one of the outside ball grooves constituting the second groove portion is defined by a second outside arc in the outer-race cross section. The corresponding one of the inside ball grooves constituting the first groove portion is defined by a first inside arc in an inner-race cross section that is perpendicular to the axis of the inner race, and the corresponding one of the inside ball grooves constituting the second groove portion is defined by a second inside arc in the inner-race cross section. Where a radius of the first outside arc and a radius of the second outside arc are compared with each other and a radius of the first inside arc and a radius of the second inside arc are compared with each other, at least one of the radius of the second outside arc and the radius of the second inside arc is larger than a corresponding at least one of the radius of the first outside arc and the radius of the first inside arc, namely, namely, the radius of the second outside arc is larger than the radius of the first outside arc, and/or the radius of the second inside arc is larger than the radius of the first inside arc. It is preferable that the each of the least one of the radius of the second outside arc and the radius of the second inside arc is larger than a radius of each of the balls that is larger than the corresponding one of the at least one of the radius of the first outside arc and the radius of the first inside arc.

The above-described features that the radial distance in the first groove portion is increased in the direction toward the opening end in the reference state and that the radial distance in the second groove portion is reduced in the direction toward the opening end in the reference state, may be expressed also as a feature that each of the balls, which is disposed in a corresponding one of the groove portions, is interposed between one of the outside ball grooves and one of the inside ball grooves that cooperate with each other to constitute the corresponding one of the groove portions, and is in contact at outer and inner contact points with the one of the outside ball grooves and the one of the inside ball grooves, respectively, wherein an outer tangent that is tangent to each of the balls at the outer contact point and an inner tangent that is tangent to each of the balls at the inner contact point cooperate with each other to define an opening angle at an intersection of the outer tangent and the inner tangent, and wherein, in the reference state, the opening angle in the first groove portion is open toward the opening end of the outer race, while the opening angle in the second groove portion is open toward a bottom end that is the other of the axially opposite ends of the outer race.

According to a second aspect of the invention, in the constant velocity joint according to the first aspect of the invention, the radius of the second outside arc is larger than the radius of the first outside arc, and the radius of the second inside arc is larger than the radius of the first inside arc.

According to a third aspect of the invention, in the constant velocity joint according to the first or second aspect of the invention, the radial distance between the corresponding one of the outside ball grooves and the corresponding one of the inside ball grooves, which cooperate with each other to constitute the second groove portion, is alternately reduced and increased in the direction toward the opening end of the outer race, during rotation of the constant velocity joint in a state in which the joint angle is not smaller than a predetermined angle value.

According to the first aspect of the present invention, the radius of the second outside arc of the outside ball groove of the outer race constituting the second groove portion is larger than the radius of the first outside arc of the outside ball groove of the first groove portion wherein the first outside arc and the second outside arc are in the outer-race cross section that is perpendicular to the axis of the outer race, and/or the radius of the second inside arc of the inside ball groove of the inner race constituting the second groove portion is larger than the radius of the first inside arc of the inside ball groove of the first groove portion wherein the first inside arc and the second inside arc are in the inner-race cross section that is perpendicular to the axis of the inner race. Thus, in a state in which a high torque is applied to the constant velocity joint and accordingly a load applied to the ball is increased, it is possible to reduce the load applied to the ball in the second groove portion. As a result, noise and vibration generated when the ball in the second groove portion is unlocked can be suppressed.

According to the second aspect of the present invention, since the second outside radius of arc of the outside ball groove of the second groove portion is larger than the first outside radius of arc of the outside ball groove of the first groove portion, and the radius of the second inside arc of the inside ball groove of the second groove portion is larger than the radius of the first inside arc of the inside ball groove of the first groove portion. Thus, when the high torque is applied to the constant velocity joint, the load applied to the ball in the second groove portion can be effectively reduced.

According to the third aspect of the invention, the radial distance between the corresponding one of the outside ball grooves and the corresponding one of the inside ball grooves, which cooperate with each other to constitute the second groove portion, is alternately reduced and increased in the direction toward the opening end of the outer race, during rotation of the constant velocity joint in the state in which the joint angle is not smaller than the predetermined angle value, so that the ball of the second groove portion is locked in a range where the above-described opening angle includes 0. At this time, even when the torque applied to the constant velocity joint is high, the load applied to the ball of the second groove portion is reduced, and thus it is possible to suppress noise and vibration generated when the locking of the ball of the second groove portion is released.

### BRIEF DESCRIPTION OF THE DRAWINGS

FIG. 1 is an assembly view (perspective view) showing an internal structure of a constant velocity joint for a vehicle to which the present invention is applied;

FIG. 2 is a cross-sectional view of the constant velocity joint of FIG. 1, taken in a plane containing axes of outer and inner races of the constant velocity joint;

FIG. 3 is a schematic view as seen from a direction of arrow A shown in FIG. 2;

FIG. 4 is a diagram showing a relationship between an opening angle and a joint angle of the constant velocity joint;

FIG. 5 is a diagram illustrating a mechanism in which noise is generated when a ball of a second groove portion is locked;

FIG. 6 is a diagram showing measurement results of the noise generated in vicinity of a drive shaft;

FIG. 7 is a diagram showing a torque transmission path when a torque is inputted to the constant velocity joint;

FIG. 8 is a table showing a relationship between a curvature radius of an outside ball groove of the outer race and a curvature radius of an inside ball groove of the inner race;

FIGS. 9A and 9B are diagrams showing loci of contact points between the ball and outside and inside ball grooves when the torque is inputted to the constant velocity joint; and

FIG. 10 is a table summarizing ball groove gaps, load sharing and effects in each of low and high torque regions.

### DETAILED DESCRIPTION OF PREFERRED EMBODIMENT

Hereinafter, an embodiment of the present invention will be described in detail with reference to the drawings. In the following embodiment, the drawings are simplified or deformed as appropriate, and a dimensional ratio, a shape and the like of each portion are not necessarily drawn accurately.

### Embodiment

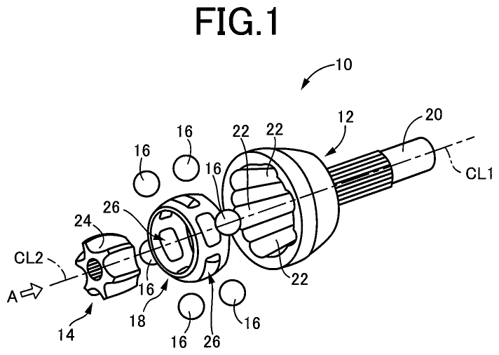

FIG. 1 is an assembly view (perspective view) showing an internal structure of a constant velocity joint 10 for a vehicle to which the present invention is applied. The constant velocity joint 10 is a well-known constant velocity universal joint that is provided between two rotary shafts and transmits rotation between the two rotary shafts even when a joint angle defined by axes of the respective two rotary shafts is changed.

The constant velocity joint 10 includes an outer race 12 formed in a cup shape, an inner race 14 disposed inside the outer race 12 in a radial direction of the outer race 12, a plurality of (six in the present embodiment) balls 16 interposed between the outer race 12 and the inner race 14 to transmit a torque between the outer race 12 and the inner race 14, and a cage 18 holding the plurality of balls 16 so as not to fall off from later-described outside ball grooves 22 of the outer race 12 and later-described inside ball grooves 24 of the inner race 14.

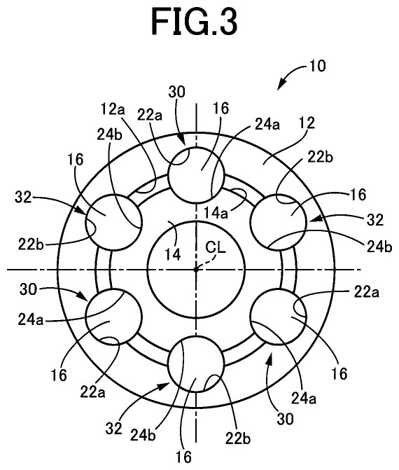

The outer race 12 is provided so as to be integrally rotatable with a rotary shaft 20 connected to the outer race 12. The cup-shaped outer race 12 has an opening end that is one of its axially opposite ends, and is connected at the other of its axially opposite ends to the rotary shaft 20. The plurality of (six in this embodiment) outside ball grooves 22 equal in number to the balls 16 are provided in an inner circumferential surface 12a (see FIG. 3) of the cup-shaped outer race 12. The outside ball grooves 22 extend in a direction of an axis CL1 of the outer race 12 from the opening end of the outer race 12 toward a bottom end that is the above-described other of the axially opposite ends of the outer race 12. The plurality of outside ball grooves 22 are provided at equal angular intervals in the inner circumferential surface 12a of the outer race 12.

The inner race 14 has an annular shape and is disposed inside the cup-shaped outer race 12 in the radial direction of the outer race 12. The inner race 14 is rotatable about its axis CL2 passing through the center of the annular shape. The plurality of (six in the present embodiment) inside ball grooves 24 equal in number to the outside ball grooves 22 are provided in an outer circumferential surface 14a (see FIG. 3) of the inner race 14. The inside ball grooves 24 extend in a direction of the axis CL2. A plurality of inside ball grooves 24 are provided at equal angular intervals in a circumferential direction of the inner race 14. An inner circumferential surface of the inner race 14 is provided with spline teeth for spline engagement with a rotary shaft (not shown).

The balls 16 are formed in a spherical shape, and are made of a metal material. The balls 16 are interposed between the outside ball grooves 22 of the outer race 12 and the inside ball grooves 24 of the inner race 14. The balls 16 are arranged one by one between the outside ball grooves 22 and the inside ball grooves 24. The balls 16 are swingable (rollable) within the outside ball grooves 22 and the inside ball grooves 24.

The balls 16 have a function of transmitting a torque transmitted from one of the outer race 12 and the inner race 14 to the other. At the time of torque transmission, the balls 16 are rotated together with the outer race 12 and the inner race 14 about the axes CL1, CL2 (hereinafter referred to as “axis CL” when they are not distinguished from each other). At this time, the balls 16 are rolled and moved along groove shapes of the outside ball grooves 22 and the inside ball grooves 24 in accordance with the joint angle θ of the constant velocity joint 10. The joint angle θ corresponds to an intersection angle defined by the axis CL1 and the axis CL2 is 0 [deg] in a reference state in which the axis CL1 of the outer race 12 and the axis CL2 of the inner race 14 lie in a straight line.

The cage 18 is formed in an annular shape, and has an inner circumferential surface and an outer circumferential surface, both of which are formed in a smooth curved surface shape. The cage 18 is interposed between the outer race 12 and the inner race 14 in the radial direction centered on the axis CL. The cage 18 is provided with pockets 26 holding the balls 16 so as not to fall off, such that the pockets 26 are in the same number as the balls 16 (six in this embodiment) and arranged at equal angular intervals in a circumferential direction of the cage 18. The pockets 26 penetrate between the inner circumferential surface and the outer circumferential surface of the cage 18, and are formed in a generally rectangular shape elongated in the circumferential direction of the cage 18. By accommodating the balls 16 in the respective pockets 26, the balls 16 are always held by the cage 18 at equiangular positions in the circumferential direction.

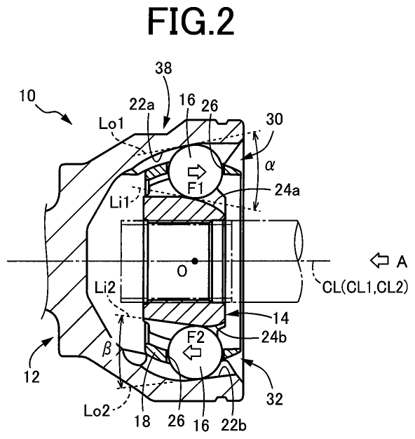

FIG. 2 is a cross-sectional view of the constant velocity joint 10 of FIG. 1, taken in a plane passing through centers of two of the balls 16 and containing the axis CL. The cross-sectional view shown in FIG. 2 shows the reference state in which the axis CL1 of the outer race 12 and the axis CL2 of the inner race 14 lie in a straight line and the joint angle θ is 0 degree [0 deg].

FIG. 3 is a schematic view as seen from a direction of arrow A shown in FIG. 2. In FIG. 3, the cage 18 is omitted. The outside ball grooves 22 provided in the inner circumferential surface 12a of the outer race 12 consist of first outside ball grooves 22a and second outside ball grooves 22b. The first outside ball grooves 22a and the second outside ball grooves 22b are alternately arranged at equal angular intervals in the circumferential direction of the outer race 12. In the present embodiment, since six outside ball grooves 22 are provided, three first outside ball grooves 22a and three second outside ball grooves 22b are alternately arranged at intervals of 60 degrees, as shown in FIG. 3. In addition, each one of the three first outside ball grooves 22a is disposed in a position opposed to a corresponding one of the three second outside ball grooves 22b across the axis CL1.

The inside ball grooves 24 provided in the outer circumferential surface 14a of the inner race 14 consist of first inside ball grooves 24a and second inside ball grooves 24b. The first inside ball grooves 24a and the second inside ball grooves 24b are alternately arranged at equal angular intervals in the circumferential direction of the inner race 14. In the present embodiment, since six inside ball grooves 24 are provided, three first inside ball grooves 24a and three second inside ball grooves 24b are alternately arranged at intervals of 60 degrees, as shown in FIG. 3. In addition, each one of the three first inside ball grooves 24a is disposed in a position opposed to a corresponding one of the three second inside ball grooves 24b across the axis CL2.

Each one of the three first outside ball grooves 22a and a corresponding one of the three first inside ball grooves 24a are disposed in the same position in the circumferential direction about the axis CL. In other words, each of the three first outside ball grooves 22a and a corresponding one of the three first inside ball grooves 24a are disposed in respective positions that overlap each other (namely, opposed to each other) when viewed in the radial direction. The ball 16 for torque transmission is interposed between each of the three first outside ball grooves 22a and a corresponding one of the three first inside ball grooves 24a.

Each one of the three second outside ball grooves 22b and a corresponding one of the three second inside ball grooves 24b are disposed in the same position in the circumferential direction about the axis CL. In other words, each of the three second outside ball grooves 22b and a corresponding one of the three second inside ball grooves 24b are disposed in respective positions that overlap each other (namely, opposed to each other) when viewed in the radial direction. The ball 16 for torque transmission is interposed between each of the three second outside ball grooves 22b and a corresponding one of the three second inside ball grooves 24b.

The cage 18 is interposed in an annular space formed between the outer race 12 and the inner race 14, and is rotated about a joint center point O (shown in FIG. 2) when the torque is transmitted between the outer race 12 and the inner race 14.

The six outside ball grooves 22 and the six inside ball grooves cooperate to define six groove portions, such that each of the balls 16 is disposed in a corresponding one of the six groove portions. The six groove portions include three first groove portions 30 each one of which is constituted by a corresponding one the three first outside ball grooves 22a and a corresponding one of the three second inside ball grooves 24b. The six groove portions further include three second groove portions 32 each one of which is constituted by a corresponding one the three second outside ball grooves 22b and a corresponding one of the three second inside ball grooves 24b. As shown in FIG. 3, the three first groove portions 30 and the three second groove portions 32 are alternately arranged in the circumferential direction about the axis CL.

As shown in FIG. 2 that shows the reference state in which the joint angle θ is 0 degree [0 deg], in each of the first groove portions 30, an opening angle α, at which a corresponding one of the balls 16 is pinched between a corresponding one of the first outside ball grooves 22a and a corresponding one the first inside ball grooves 24a, opens toward the opening end of the outer race 12 in the reference state. The opening angle α is an angle defined by an intersection of a tangent Lo1 between the corresponding first outside ball groove 22a and the corresponding ball 16 and a tangent Li1 between the corresponding first inside ball groove 24a and the corresponding ball 16. The opening angle α is also an angle defined by a center locus of the corresponding ball 16 rolling in the corresponding first outside ball groove 22a and a center locus of the corresponding ball 16 rolling in the corresponding first inside ball groove 24a. The above-described feature that the opening angle α opens toward the opening end of the outer race 12 in the reference state may be expressed as a feature that a radial distance between a groove bottom 34 of the corresponding first outside ball groove 22a and a groove bottom 36 of corresponding first inside ball groove 24a in the radial direction is generally increased in a direction toward the opening end of the outer race 12 in the reference state.

Further, as shown in FIG. 2 that shows the reference state, in each of the second groove portions 32, an opening angle β, at which a corresponding one of the balls 16 is pinched between a corresponding one of the second outside ball grooves 22b and a corresponding one of the second inside ball grooves 24b, opens toward the bottom end of the outer race 12 in the reference state. The opening angle β is an angle defined by an intersection of a tangent Lo2 between the corresponding second outside ball groove 22b and the corresponding ball 16 and a tangent Li2 between the corresponding second inside ball groove 24b and the corresponding ball 16. The opening angle β is also an angle defined by a center locus of the corresponding ball 16 rolling in the corresponding second outside ball groove 22b and a center locus of the corresponding ball 16 rolling in the corresponding second inside ball groove 24b. The above-described feature that the opening angle β opens toward the bottom end of the outer race 12 in the reference state may be expressed as a feature that a radial distance between the groove bottom 34 of the corresponding second outside ball groove 22b and the groove bottom 36 of the corresponding second inside ball groove 24b in the radial direction is generally reduced in the direction toward the opening end of the outer race 12 in the reference state.

As described above, since the opening angle α and the opening angle β are opened in different directions from each other and the opening angle α and the opening angle β are alternately arranged, during torque transmission, a load F1 in the direction of the axis CL acting on each of the balls 16 disposed in the first groove portions 30 and a load F2 in the direction of the axis CL acting on each of the balls 16 disposed in the second groove portions 32 act in directions to cancel each other out. As a result, a total value of loads in the direction of axis CL acting on the balls 16 becomes small. In relation to this, since the force in the direction of axis CL acting on the cage 18 via the balls 16 is reduced, a sliding resistance generated between the inner circumferential surface 12a of the outer race 12 and the outer circumferential surface of the cage 18 is reduced, and a sliding resistance generated between the outer circumferential surface 14a of the inner race 14 and the inner circumferential surface of the cage 18 is reduced.

As a result, a torque transmission rate of the constant velocity joint 10 is increased and a fuel consumption (or electricity consumption) is improved. In addition, during an idle operation of an engine, the vibration of the engine (idle vibration) is easily transmitted to a driver of the vehicle. However, since the sliding resistance of the constant velocity joint 10 is reduced, the vibration of the engine is hardly transmitted to the vehicle driver. During normal running of the vehicle, the torque inputted to the constant velocity joint 10 is relatively low, so that the above-described effects of improving the fuel consumption (electricity consumption) and reducing the idle vibration can be suitably obtained in a low torque region.

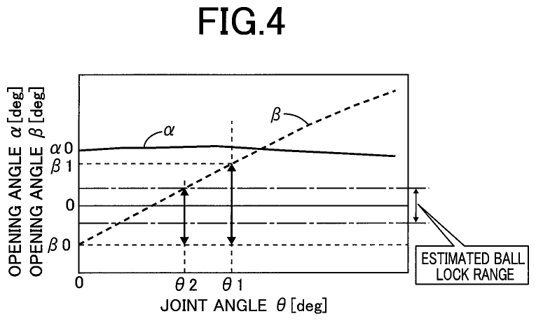

The constant velocity joint 10 is configured such that when the joint angle θ becomes equal to or larger than a predetermined angle θ2 (see FIG. 4), the opening angle β in the second groove portion 32 crosses 0 degree (0 deg), namely, the radial distance between the outside and inside ball grooves 22, 24, which cooperate with each other to constitute the second groove portion 32, is alternately reduced and increased in the direction toward the opening end of the outer race 12, during rotation of the constant velocity joint 10. When the opening angle β becomes 0 degree or near 0 degree, the load F2 acting on the ball 16 disposed in the second groove portion 32 becomes small. As a result, the ball 16 is not forced by the second outside ball groove 22b and the second inside ball groove 24b in direction of the axis CL, and the ball 16 is locked between the second outside ball groove 22b and the second inside ball groove 24b. At this time, an energy is accumulated in the ball 16, and then, when the ball 16 is released from the locked state, the ball 16 suddenly starts to be moves, which may cause noise and vibration.

FIG. 4 is a diagram illustrating a relationship between each of the opening angle α and the opening angle β, and the joint angle θ in the constant velocity joint 10. In FIG. 4, a horizontal axis represents the joint angle θ, and a vertical axis represents maximum values of change amounts of the opening angles α, β, with reference to reference opening angles α0, β0 when the joint angle θ is 0 degree (0 deg). When the joint angle θ is 0 degree, the opening angles α, β are maintained at the reference opening angles α0, β0, respectively, regardless of a rotation angle of the constant velocity joint 10. That is, when the joint angle θ is 0 degree, the opening angles α, β are constant regardless of the rotation angle of the constant velocity joint 10.

While the constant velocity joint 10 is rotated once (by 360 degrees), the opening angle α is changed between the reference opening angle α0 (at the joint angle θ being 0 degree) and the opening angle α indicated by solid line. As shown in FIG. 4, the opening angle α has a small amount of change from the reference opening angle α0 in an entire range of the joint angle θ used during running of the vehicle. That is, the opening angle α is hardly changed while the constant velocity joint 10 is rotated once. Further, the opening angle α has a value larger than 0 degree in the entire range of the joint angle θ.

While the constant velocity joint 10 is rotated once, the opening angle β is changed between the reference opening angle β0 (at the joint angle θ being 0 degree) and the opening angle β indicated by broken line while the constant velocity joint 10 is rotated once (by 360 degrees). For example, at the joint angle θ1, during one rotation of the constant velocity joint 10, the opening angle β is changed between the reference opening angle β0 and the opening angle β1. Therefore, at the joint angle θ1, during the one rotation of the constant velocity joint 10, the opening angle β crosses an estimated ball lock range sandwiched by one-dot chain lines. The estimated ball lock range is a range in which the opening angle β crosses 0 degree, and is a region in which the load F2 in the direction of the axis CL acting on the ball 16 becomes 0 or substantially 0, and the ball 16 is temporarily locked during the rotation of the constant velocity joint 10. Therefore, at the joint angle θ1, the locking of the ball 16 occurs in the second groove portion 32 during the rotation of the constant velocity joint 10.

As shown in FIG. 4, in the constant velocity joint 10, as the joint angle θ is increased, the amount of change in the opening angle β during the rotation of the constant velocity joint 10 is increased. When the joint angle θ becomes equal to or larger than the predetermined angle θ2, the ball 16 is locked in the second groove portion 32 because the ball 16 passes through the estimated ball lock range in which the opening angle β crosses 0 degree during the rotation of the constant velocity joint 10.

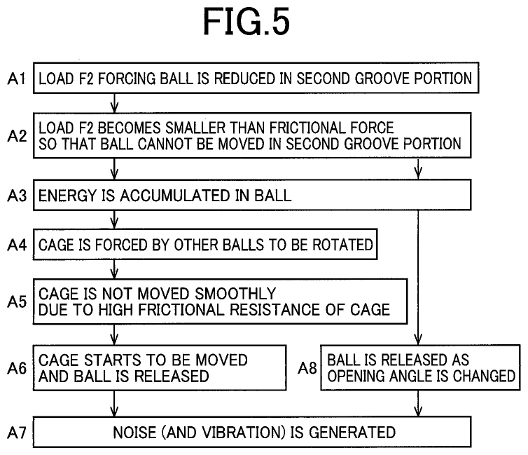

FIG. 5 is a diagram illustrating a mechanism in which noise and vibration are generated by the ball 16 being locked in the second groove portion 32.

In stage A1 shown in FIG. 5, as the opening angle β of the second groove portion 32 approaches the estimated ball locking range described above, the load F2 forcing the ball 16 is reduced. In stage A2, the opening angle β falls within the estimated ball lock range so that the load F2 acting on the ball 16 is less than or equal to frictional force acting between the ball 16 and the second outside and inside ball grooves 22b, 24b. At this time, the ball 16 cannot be pushed out, and the ball 16 is locked between the second outside ball groove 22b and the second inside ball groove 24b. In stage A3, the ball 16 in the locked state is forced by other balls 16 through the cage 18, so that an energy due to the forced applied to the ball 16 is accumulated. In stage A4, the cage 18 is forced by the other balls 16 to be rotated. In stage A5, the cage 18 tries to move the ball 16, but the cage 18 is not moved smoothly because of the high frictional resistance between a spherical surface of the cage 18 and spherical surfaces of the respective outside and inside ball grooves 22 24. In stage A6, the cage 18 starts to be moved and the ball 16 is released. However, since the accumulated energy is suddenly released, the ball 16 and the cage 18 suddenly are moved, and thus noise is generated in stage A7. Alternatively, in stage A8, the ball 16 is released as the opening angle β is changed by the rotation of the constant velocity joint 10, but at this time as well, the ball 16 and the cage 18 start to be rapidly moved, and noise and vibration are generated in the stage A7.

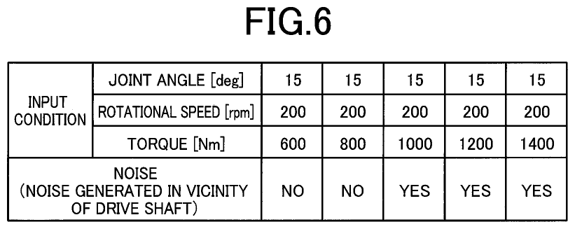

FIG. 6 shows measurement results obtained by measuring the presence or absence of noise for each level of torque inputted to the constant velocity joint 10. The joint angle θ is fixed at 15 degrees (15 deg), and the rotational speed is fixed at 200 rpm. When the joint angle θ is 15 degrees, the opening angle β crosses 0 degree during the rotation of the constant velocity joint 10. As shown in FIG. 6, no noise was detected when the input torque was equal to or lower than 800 Nm, but noise was detected when the input torque was equal to or higher than 1000 Nm. As described above, as the torque inputted to the constant velocity joint 10 is increased, the load applied to the ball 16 is increased and the energy accumulated in the ball 16 is increased when the ball 16 is locked, thereby generating noise and vibration.

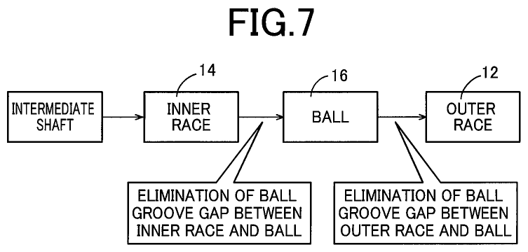

FIG. 7 shows a torque transmission path when the torque is inputted to the constant velocity joint 10. When the torque is inputted to an intermediate shaft (not shown) that is spline-fitted to the inner race 14, the torque is transmitted to the inner race 14. Then, a ball groove gap Gapi defined between the inside ball groove 24 of the inner race 14 and the ball 16 is eliminated, and the inner race 14 presses the ball 16. Then, a ball groove gap Gapo defined between the ball 16 and the outside ball groove 22 of the outer race 12 is eliminated, and the ball 16 press the outer race 12. As a result, the torque is transmitted to the outer race 12.

As described above, when the constant velocity joint 10 transmits the torque, the ball groove gap Gapi between the inside ball groove 24 and the ball 16 and the ball groove gap Gapo between the ball 16 and the outside ball groove 22 are eliminated. If the ball groove gap Gapo and the ball groove gap Gapi (hereinafter, ball groove gaps Gap when they are not distinguished) are made different between the first groove portion 30 and the second groove portion 32, the load applied to the ball 16 during the torque transmission can be made different depending on whether the ball 16 is of the first groove portion 30 or the second groove portion 32. For example, when the ball groove gaps Gap of specific ones of the balls 16 are increased, the other balls 16 come into contact with the outside ball grooves 22 and the inside ball grooves 24 earlier to receive the load, and the load applied to the specific ball 16 is reduced. Therefore, as the ball groove gaps Gap are increased, the load applied to the ball 16 is reduced. Since the noise and vibration generated when the ball 16 of the second groove portion 32 is unlocked, are generated when the load applied to the ball 16 is increased, the noise and vibration are suppressed by reducing the load applied to the ball 16 of the second groove portion 32.

In consideration of the above, in the constant velocity joint 10, the load applied to the ball 16 of the second groove portion 32 is set to be larger than the load applied to the ball 16 of the first groove portion 30 in the low torque region in which the torque inputted to the constant velocity joint 10 is relatively low. That is, in the low torque region, the ball groove gaps Gap defined in the second groove portion 32 are set to be smaller than the ball groove gaps Gap defined in the first groove portion 30.

Further, in the high torque region in which the torque inputted to the constant velocity joint 10 is relatively high, the load applied to the ball 16 of the second groove portion 32 is set to be smaller than the load applied to the ball 16 of the first groove portion 30. That is, in the high torque region, the ball groove gaps Gap defined in the second groove portion 32 are set to be larger than the ball groove gaps Gap defined in the first groove portion 30.

To be more specific, a curvature radius Ro2, which is a radius of a second outside arc defining each of the second outside ball grooves 22b in an outer-race cross section that is perpendicular to the axis CL1 of the outer race 12, is larger than a curvature radius Ro1, which is a radius of a first outside arc defining each of the first outside ball grooves 22a in the outer-race cross section. The curvature radius Ro1 also corresponds to a radius of an arc when each of the first outside ball grooves 22a is viewed in the direction of the axis CL1 of the outer race 12. The curvature radius Ro2 also corresponds to a radius of an arc when each of the second outside ball grooves 22b is viewed in the direction of the axis CL1 of the outer race 12. It is preferable that the curvature radius Ro2 is larger than a radius of each of the balls 16 and/or the curvature radius Ro1 is smaller than the radius of each of the balls 16.

In addition, a curvature radius Ri2, which is a radius of a second inside arc defining each of the second inside ball grooves 24b in an inner-race cross section that is perpendicular to the axis CL2 of the inner race 14, is larger than a curvature radius Ri1, which is a radius of a first inside arc defining each of the first inside ball grooves 24a in the inner-race cross section The curvature radius Ri1 also corresponds to a radius of an arc when each of the first inside ball grooves 24a is viewed in the direction of the axis CL2 of the inner race 14. The curvature radius Ri2 also corresponds to a radius of an arc when each of the second inside ball grooves 24b is viewed in the direction of the axis CL2 of the inner race 14. It is preferable that the curvature radius Ri2 is larger than the radius of each of the balls 16 and/or the curvature radius Ri1 is smaller than the radius of each of the balls 16.

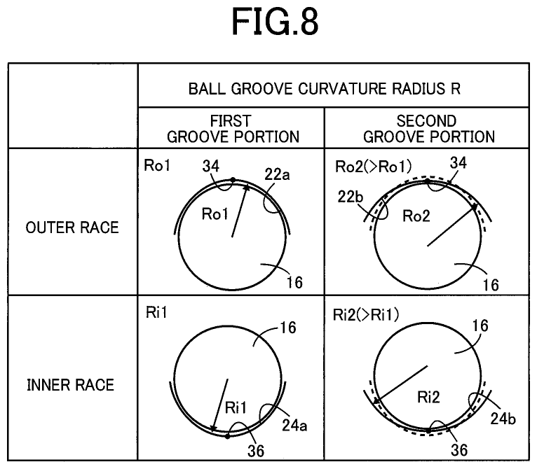

FIG. 8 shows a relationship between the outside ball grooves 22 of the outer race 12 and the inside ball grooves 24 of the inner race 14 in terms of the curvature radius R. As can be seen from FIG. 8, in the outer race 12, the curvature radius Ro2 of each of the second outside ball grooves 22b is larger than the curvature radius Ro1 of each of the first outside ball grooves 22a. In the inner race 14, the curvature radius Ri2 of each of the second inside ball grooves 24b is larger than the curvature radius Ri1 of each of the first inside ball grooves 24a.

With the first and second outside ball grooves 22a, 22b and the first and second inside ball grooves 24a, 24b being formed as described above, in vicinity of the groove bottom 34 of each of the outside ball grooves 22, a ball groove gap Gapo1 in each of the first outside ball grooves 22a is larger than a ball groove gap Gapo2 in each of the second outside ball grooves 22b. On the other hand, in a position away from the groove bottom 34 of each of the outside ball grooves 22, the ball groove gap Gapo2 in each of the second outside ball grooves 22b is larger than the ball groove gap Gapo1 in each of the first outside ball grooves 22a.

Therefore, when the ball 16 is near the groove bottom 34 of the outside ball groove 22, the load applied to the ball 16 in the second outside ball groove 22b is larger than the load applied to the ball 16 in the first outside ball groove 22a. On the other hand, when the ball 16 is located away from the groove bottom 34 of the outside ball groove 22, the load applied to the ball 16 in the first outside ball groove 22a is larger than the load applied to the ball 16 in the second outside ball groove 22b.

In addition, in vicinity of the groove bottom 36 of each of the inside ball grooves 24, a ball groove gap Gapi1 in each of the first inside ball grooves 24a is larger than a ball groove gap Gapi2 in each of the second inside ball grooves 24b. On the other hand, in a position away from the groove bottom 36 of each of the inside ball grooves 24, the ball groove gap Gapi2 in each of the second inside ball grooves 24b is larger than the ball groove gap Gapi1 in each of the first inside ball grooves 24a.

Therefore, when the ball 16 is near the groove bottoms 36 of the inside ball groove 24, the load applied to the ball 16 in the second inside ball groove 24b is larger than the load applied to the ball 16 in the first inside ball groove 24a. On the other hand, when the ball 16 is located away from the groove bottom 36 of the inside ball groove 24, the load applied to the ball 16 in the first inside ball groove 24a is larger than the load applied to the ball 16 in the second inside ball groove 24b.

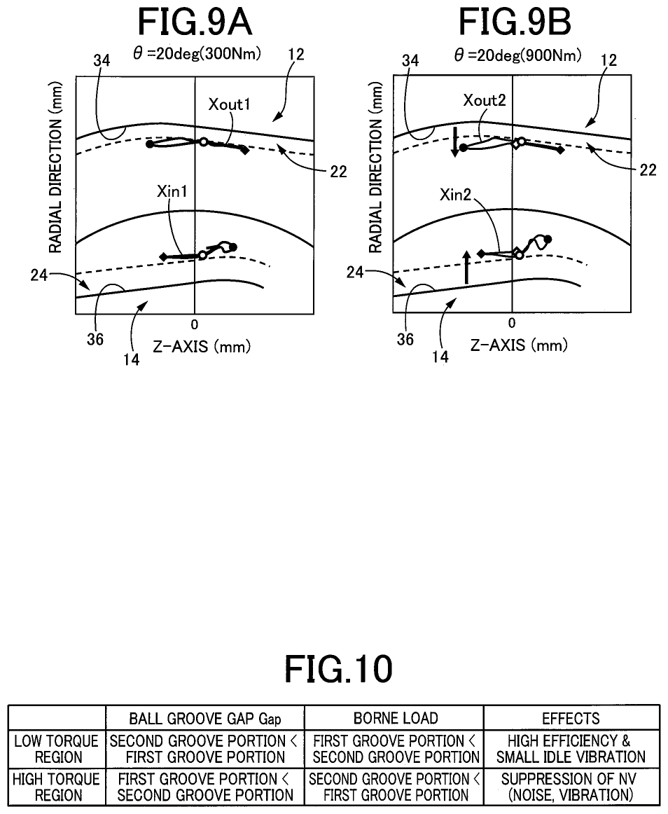

The ball 16 is in contact at outer and inner contact points with the outside ball groove 22 and the inside ball groove 24, respectively, and the outer and inner contact points are changed depending on whether the torque applied to the constant velocity joint 10 is large or small. FIGS. 9A and 9B show loci of the respective outer and inner contact points between the ball 16 and the outside and inside ball grooves 22, 24 when the torque is inputted to the constant velocity joint 10. In each of FIGS. 9A and 9B, a vertical direction corresponds to the radial direction, and a horizontal direction corresponds to the direction of the axis CL. FIG. 9A shows a state in which the joint angle θ is 20 degrees (20 deg) and the torque inputted to the constant velocity joint 10 is 300 Nm that is relatively low. FIG. 9B shows a state in which the joint angle θ is 20 degrees and the torque inputted to the constant velocity joint 10 is 900 Nm that is relatively high.

Where a locus Xout1 of the outer contact point between the ball 16 and the outside ball groove 22 shown in FIG. 9A is compared with a locus Xout2 of the outer contact point between the ball 16 and the outside ball groove 22 shown in FIG. 9B, the locus Xout2 is generally in a position more distant from the groove bottom 34 of the outside ball groove 22 than the locus Xout1. Where a locus Xin1 of the inner contact point between the ball 16 and the inside ball groove 24 shown in FIG. 9A is compared with a locus Xin2 of the inner contact point between the ball 16 and the inside ball groove 24 shown in FIG. 9B, the locus Xin2 is generally in a position more distant from the groove bottom 36 of the inside ball groove 24 than the locus Xin1.

Therefore, in the low torque region in which the torque inputted to the constant velocity joint 10 is relatively small, the outer contact point at which the ball 16 is in contact with the outside ball groove 22 is located in the vicinity of the groove bottom 34, and the inner contact point at which the ball 16 is in contact with the inside ball groove 24 is located in the vicinity of the groove bottom 36. In the high torque region in which the torque inputted to the constant velocity joint 10 is relatively large, the outer contact point at which the ball 16 is in contact with the outside ball groove 22 is located in a position away from the groove bottom 34, and the inner contact point at which the ball 16 is in contact with the inside ball groove 24 is located in a position away from the groove bottom 36.

As described above, in the low torque region in which the torque inputted to the constant velocity joint 10 is relatively low, the ball 16 is in contact with the outside ball groove 22 in the vicinity of the groove bottom 34. At this time, the ball groove gap Gapo1 between the ball 16 and the first outside ball groove 22a is larger than the ball groove gap Gapo2 between the ball 16 and the second outside ball groove 22b. Therefore, among the total load applied to the balls 16, the load (shared load) borne by the balls 16 in the second outside ball grooves 22b is larger than the load (shared load) borne by the balls 16 in the first outside ball grooves 22a.

Further, in the low torque region, the ball 16 is in contact with the inside ball groove 24 near the groove bottom 36. At this time, the ball groove gap Gapi1 between the ball 16 and the first inside ball groove 24a is larger than the ball groove gap Gapi2 between the ball 16 and the second inside ball groove 24b. Therefore, among the total load applied to the balls 16, the load (shared load) borne by the balls 16 in the second inside ball grooves 24b is larger than the load (shared load) borne by the balls 16 in the first inside ball grooves 24a.

As described above, in the low torque region in which the torque inputted to the constant velocity joint 10 is relatively low, the load borne by the balls 16 in the second groove portions 32 is larger than the load borne by the balls 16 in the first groove portions 30. At this time, the load acting on the balls 16 in the first groove portions 30 and the load acting on the balls 16 in the second groove portions 32 cancel each other out, whereby the above-described effects of increasing the torque transmission efficiency and reducing the idle vibration can be obtained. Further, since the torque inputted to the constant velocity joint 10 is relatively low, noise and vibration shown in FIG. 6 do not occur.

On the other hand, in the high torque region in which the torque inputted to the constant velocity joint 10 is relatively high, the ball 16 is in contact with the outside ball groove 22 in a position away from the groove bottom 34. At this time, the ball groove gap Gapo2 between the ball 16 and the second outside ball groove 22b is larger than the ball groove gap Gapo1 between the ball 16 and the first outside ball groove Gapo1. Therefore, among the total load applied to the balls 16, the load (shared load) borne by the balls 16 in the second outside ball grooves 22b is smaller than the load (shared load) borne by the balls 16 in the first outside ball grooves 22a.

Further, in the high torque region, the ball 16 is in contact with the inside ball groove 24 in a position away from the groove bottom 36. At this time, the ball groove gap Gapi2 between the ball 16 and the second inside ball groove 24b is larger than the ball groove gap Gapi1 between the ball 16 and the first inside ball groove 24a. Therefore, among the total load applied to the balls 16, the load (shared load) borne by the balls 16 in the second inside ball grooves 24b is smaller than the load (shared load) borne by the balls 16 in the first inside ball grooves 24a.

As described above, in the high torque region in which the torque inputted to the constant velocity joint 10 is relatively high, the load borne by the balls 16 in the second groove portions 32 is smaller than the load borne by the balls 16 in the first groove portions 30. That is, the load applied to the balls 16 sandwiched between the second outside ball grooves 22b and the second inside ball grooves 24b is smaller than the load applied to the balls 16 sandwiched between the first outside ball grooves 22a and the first inside ball grooves 24a. Therefore, when the ball 16 is temporarily locked between the second outside and inside ball grooves 22b, 24b with the opening angle β in the second groove portion 32 becoming close to 0 degree (0 deg), the energy accumulated in the ball 16 becomes small. As a result, noise and vibration, which are generated when the ball 16 of the second groove portion 32 is unlocked, are suppressed.

FIG. 10 is a table summarizing the effects obtained by differentiating the curvature radius R of the outside ball grooves 22 and the inside ball grooves 24 between the first groove portion 30 and the second groove portion 32. As shown in FIG. 10, in the constant velocity joint 10, the ball groove gaps Gapo1, Gapi1 in the first groove portion 30 are larger than the ball groove gaps Gapo2, Gapi2 in the second groove portion 32, in the low torque region. Therefore, in the constant velocity joint 10, the load borne by the balls 16 of the second groove portions 32 is larger than the load borne by the balls 16 of the first groove portions 30. In this case, the inherent effects of the constant velocity joint 10, i.e., high efficiency of torque transmission and reduction of idle vibration, can be obtained.

Further, in the high torque region, the ball groove gaps Gapo2, Gapi2 in the second groove portion 32 are larger than the ball groove gaps Gapo1, Gapi1 in the first groove portion 30. Therefore, in the constant velocity joint 10, the load borne by the balls 16 of the first groove portions 30 is larger than the load borne by the balls 16 of the second groove portions 32. At this time, since the load applied to the balls 16 of the second groove portions 32 is smaller than the load applied to the balls 16 of the first groove portions 30, the energy, which is accumulated in the balls 16 when the balls 16 of the second groove portion 32 are locked, is reduced. As a result, noise and vibration (NV), which are generated when the balls 16 of the second groove portions 32 are released, are suppressed.

As described above, according to the present embodiment, the curvature radius Ro2 of the second outside arc of the second outside ball groove 22b of the outer race 12 constituting the second groove portion 32 is larger than the curvature radius Ro1 of the first outside arc of the first outside ball grooves 22a of the inner race 14 constituting the first groove portion 30, wherein the first outside arc and the second outside arc are in the outer-race cross section that is perpendicular to the axis CL1 of the outer race 12. Further, the curvature radius Ri2 of the second inside arc of the second inside ball groove 24b of the inner race 14 constituting the second groove portion 32 is larger than the curvature radius Ri1 of the first inside arc of the first inside ball groove 24a of the inner race 14 constituting the first groove portion 30, wherein the first inside arc and the second inside arc are in the inner-race cross section that is perpendicular to the axis CL2 of the inner race 14. Thus, in a state in which a high torque is applied to the constant velocity joint 10 and accordingly a load applied to the balls 16 is increased, it is possible to reduce the load applied to the balls 16 in the second groove portions 32. As a result, noise and vibration generated when the balls 16 of the second groove portions 32 are unlocked can be suppressed.

Further, according to the present embodiment, in the second groove portion 32, when the joint angle θ becomes equal to or larger than the predetermined angle θ2, the opening angle β in the second groove portion 32 crosses 0, so that the ball 16 of the second groove portion 32 is locked in a range in which the opening angle β includes 0. At this time, even if the torque applied to the constant velocity joint 10 is high, the load applied to the ball 16 of the second groove portion 32 is reduced, so that noise and vibration generated when the ball 16 of the second groove portion 32 is unlocked can be suppressed.

Although the embodiment of the present invention has been described in detail with reference to the drawings, the present invention is also applied to other embodiments.

For example, in the above-described embodiment, the curvature radius Ro2 of the second outside arc of the second outside ball groove 22b of the second groove portion 32 is larger than the curvature radius Ro1 of the first outside arc of the first outside ball groove 22a of the first groove portion 30, and the curvature radius Ri2 of the second inside arc of the second inside ball groove 24b of the second groove portion 32 is larger than the curvature radius Ri1 of the first inside arc of the first inside ball groove 24a of the first groove portion 30. However, the present invention is not necessarily limited to this embodiment. For example, the curvature radius Ro2 in the second outside ball groove 22b of the second groove portion 32 does not necessarily have to be larger than the curvature radius Ro1 in the first outside ball groove 22a of the first groove portion 30, as long as the curvature radius Ri2 in the second inside ball groove 24b of the second groove portion 32 is larger than the curvature radius Ri1 in the first inside ball groove 24 of the first groove portion 30. Similarly, the curvature radius Ri2 in the second inside ball groove 24b of the second groove portion 32 does not necessarily have to larger than the curvature radius Ri1 in the first inside ball groove 24 of the first groove portion 30, as long as the curvature radius Ro2 in the second outside ball groove 22b of the second groove portion 32 is larger than the curvature radius Ro1 in the first outside ball groove 22a of the first groove portion 30.

It should be noted that the above-described embodiment is merely an embodiment, and the present invention can be implemented in a mode in which various changes and improvements are added based on the knowledge of those skilled in the art.

### NOMENCLATURE OF ELEMENTS

10: constant velocity joint
12: outer race
12a: inner circumferential surface
14: inner race
14a: outer circumferential surface
16: ball
22: outside ball groove
24: inside ball groove
30: first groove portion
32: second groove portion
Ri1: curvature radius (radius of arc of inside ball groove of first groove portion)
Ri2: curvature radius (radius of arc of inside ball groove of second groove portion)
Ro1: curvature radius (radius of arc of outside ball groove of first groove portion)
Ro2: curvature radius (radius of arc of outside ball groove of second groove portion)
θ: joint angle
θ2: predetermined angle
α: opening angle of first groove portion.
β: opening angle of second groove portion.

What is claimed is:

1. A constant velocity joint comprising:
a cup-shaped outer race having a plurality of outside ball grooves provided in an inner circumferential surface thereof;
an inner race having a plurality of inside ball grooves provided in an outer circumferential surface thereof, the inner race being disposed inside the outer race in a radial direction of the outer race; and
a plurality of balls interposed between the outside ball grooves and the inside ball grooves, so as to transmit a torque between the outer race and the inner race,
wherein the outside ball grooves and the inside ball grooves cooperate to constitute a plurality of groove portions, such that each of the balls is disposed in a corresponding one of the groove portions,
wherein the groove portions include a first groove portion in which a radial distance between a corresponding one of the outside ball grooves and a corresponding one of the inside ball grooves in the radial direction is increased in a direction toward an opening end that is one of axially opposite ends of the outer race, in a reference state in which axes of the outer race and the inner race lie in a straight line with a joint angle defined by the axes being 0 degree,
wherein the groove portions further include a second groove portion in which a radial distance between a corresponding one of the outside ball grooves and a corresponding one of the inside ball grooves in the radial direction is reduced in the direction toward the opening end of the outer race, in the reference state,
wherein the corresponding one of the outside ball grooves constituting the first groove portion is defined by a first outside arc in an outer-race cross section that is perpendicular to the axis of the outer race, and the corresponding one of the outside ball grooves constituting the second groove portion is defined by a second outside arc in the outer-race cross section,
wherein the corresponding one of the inside ball grooves constituting the first groove portion is defined by a first inside arc in an inner-race cross section that is perpendicular to the axis of the inner race, and the corresponding one of the inside ball grooves constituting the second groove portion is defined by a second inside arc in the inner-race cross section, and
wherein, where a radius of the first outside arc and a radius of the second outside arc are compared with each other and a radius of the first inside arc and a radius of the second inside arc are compared with each other, each of at least one of the radius of the second outside arc and the radius of the second inside arc is larger than a corresponding one of at least one of the radius of the first outside arc and the radius of the first inside arc.

2. The constant velocity joint according to claim 1,
wherein the radius of the second outside arc is larger than the radius of the first outside arc, and
wherein the radius of the second inside arc is larger than the radius of the first inside arc.

3. The constant velocity joint according to claim 1,
wherein the radial distance between the corresponding one of the outside ball grooves and the corresponding one of the inside ball grooves, which cooperate with each other to constitute the second groove portion, is alternately reduced and increased in the direction toward the opening end of the outer race, during rotation of the constant velocity joint in a state in which the joint angle is not smaller than a predetermined angle value.

4. The constant velocity joint according to claim 1,
wherein each of the balls, which is disposed in a corresponding one of the groove portions, is interposed between one of the outside ball grooves and one of the inside ball grooves that cooperate with each other to constitute the corresponding one of the groove portions, and is in contact at outer and inner contact points with the one of the outside ball grooves and the one of the inside ball grooves, respectively,
wherein an outer tangent that is tangent to each of the balls at the outer contact point and an inner tangent that is tangent to each of the balls at the inner contact point cooperate with each other to define an opening angle at an intersection of the outer tangent and the inner tangent, and
wherein, in the reference state, the opening angle in the first groove portion is open toward the opening end of the outer race, while the opening angle in the second groove portion is open toward a bottom end that is the other of the axially opposite ends of the outer race.

5. The constant velocity joint according to claim 1,
wherein the each of the least one of the radius of the second outside arc and the radius of the second inside arc is larger than a radius of each of the balls that is larger than the corresponding one of the at least one of the radius of the first outside arc and the radius of the first inside arc.
